(19) United States
(12) Patent Application Publication
(10) Pub. No.: US 2008/0005472 A1
(43) Pub. Date: Jan. 3, 2008

(54) Running applications from removable media

(75) Inventors: Yousef A. Khalidi, Bellevue, WA (US); Madhusudhan Talluri, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/479,456

(22) Filed: Jun. 30, 2006

(51) Int. Cl. G06F 12/00

(52) U.S. Cl. 711/115

(57) ABSTRACT

Off-the-shelf software can be run from a removable medium without installing the software onto the machine and without modifying the off-the-shelf software. Files and application-associated state created or modified during execution of the application that is not installed on the computer may be saved to the removable media or to a specified area of the system file system and system registry (if present).

### BACKGROUND

One of the ways that a user obtains new software for his computer is to purchase that software on a CD ROM or on some other form of removable medium. The CD ROM (or other removable medium) typically contains an application such as a tax preparation program, game or one of countless other possibilities. The CD ROM typically also includes software with which to install the application on the user's computer. The user is prompted to initiate the installing software or sometimes the installation program starts itself automatically. The installer then copies program and data files onto the user's computer. The installer typically also creates or modifies program files, folders and directories, registry entries (for those operating systems that use registries), configuration file entries, environment variables and links or shortcuts so that the application can run. Thus, typically before the user can run the application, at least some software and data files have to copied onto the user's computer. Should the user want to remove the software and any files, etc. the software created or used, the application can frequently be uninstalled, either with software utilities provided by the operating system or with software that comes with the application. Problems frequently arise with uninstallation. Sometimes all of the files, folders, directories, registry entries, links, configuration file entries, etc. that should be deleted are not deleted and sometimes files, etc. that should not be deleted are deleted. Sometimes, the files, etc. remaining on the user's computer are left in a state that causes problems with the execution of other programs.

In addition, users frequently own more than one computer and want to run the software on more than one computer. Suppose, for example, the user owns three computers. Even though the application software itself is portable, (residing on a CD ROM, for example), in order to run the application on any of his three computers, the user would have to install the software separately on each of his three machines. Installation of the application will use up space on each of the computers on which it is installed and is likely to leave data on the machine, even if the software is subsequently uninstalled. Problems may also arise where the user wants to run software on someone else's computer but does not want to leave personal information on someone else's computer. The problems of dealing with software on removable media, where the software must be installed and uninstalled is an O(n) problem. Hence, this model, although in widespread use today, has a number of disadvantages.

### SUMMARY

Users are able to purchase or acquire software on a removable medium or are able to download software from the Internet or other network onto a removable medium and are able to use the software by inserting the removable medium into a computer and running the software from the removable medium. The software may need to be installed onto a computer only once regardless of how many computers the software will be run on, or, if the software is packaged to be able to run without installation, without installing the software at all before use, thus eliminating the need to uninstall it afterwards, should that be desired.

The removable media can be read-only or read-writeable. If the removable medium is writable, the first computer on which the software is run may perform the install step and make any required configuration changes onto the removable medium. Subsequent runs of the software on this or another computer may not require installation. If the removable media is writeable, the application, and any files or state created or associated therewith, may optionally be saved back to the removable media. The software that does not have to be installed to run from the removable medium does not have to be modified from its off-the-shelf state that in the absence of the invention would have to be installed to run.

If the removable medium is read-only, the software may be packaged (optionally, post-purchase) in such a way that an install step is not needed. Alternatively, the installation step may be reduced to making only those configuration changes required, in such a way that the required configuration changes are only visible to the software on the removable medium. That is, the installation does not impact the computer on which it is installed (i.e., configuration settings on the computer are not changed as a result of installation of the software.) The user has the option to leave the state of the computer in which the removable media is inserted or connected in the state the computer would have been had the removable media not been inserted and the software not run. The software is run from the removable media by creating a sandbox such as a silo which provides an environment from which the application can be launched without installation of the software on the computer. Upon removal of the removable media, the sandbox is deleted and any remnants of the application and its state can be removed from the computer.

The silo merges a read-only view of the system file system and system registry with read-write access to the files and registry on the removable medium. The result is an isolated environment or silo that functions as a complete operating system. The silo does not have a separate instance of the operating system image.

### BRIEF DESCRIPTION OF THE DRAWINGS

In the drawings:

FIG. 1 is a block diagram illustrating an exemplary computing environment in which aspects of the invention may be implemented;

FIG. 2a-c are block diagrams of a system for running an application from a removable medium in accordance with some embodiments of the invention; and

FIG. 3 is a flow diagram of a method for running an application from a removable medium in accordance with some embodiments of the invention.

### DETAILED DESCRIPTION

### Overview

Off-the-shelf software is typically accompanied by installation software that must be run before the application can be launched. Typically the installation software copies files and data onto the computer on which the software will run. The installation software may also add or alter configuration settings and registry values so that the application can run. In accordance with embodiments of the invention, the off-the-shelf software can be run from a removable medium without installing the software onto the machine, without modifying the off-the-shelf software. In some embodiments of the invention, the state of the computer after the application is run is unchanged by the running of the application. That is, any change in state that occurs while the application is running is completely transient and results in no changes to any persisted (permanent or saved) files on the computer. In some embodiments of the invention, files created or modified during execution of the application that is not installed on the computer but is run from the removable medium, are saved to the removable media. In some embodiments of the invention, files created or modified during execution of the not-installed application are saved to a specified area of the computer's file system.

Removable media include removable disks, CD ROMS, DVDs, USB keys, flash memory devices, flash drives, pen drives, chip sticks, thumb drives, remote file shares, network attached storage and other such devices not yet known or developed. To make the off-the-shelf software able to be run without installation and without leaving application-associated state on the computer, the installation software is run once for initialization purposes and the values set by the installation software are saved on the removable medium. This process is referred to as provisioning the removable medium. Provisioning the removable medium may occur once to create a master or may occur the first time the removable medium is inserted into or other connected to any computer. Alternatively, provisioning may occur the first time the removable disk is inserted into a particular computer. When the removable medium is inserted into the computer on which the application will be run, an application silo is created. The file system exposed to the application silo is a view which includes both the entries in the computer's file system or a subset thereof, and the files on the removable medium. The registry exposed to the application silo is a view which includes both the entries in the computer's registry or a subset thereof and the registry values on the removable medium. Thus, the application silo acts as an isolated execution environment that functions like a regular system to the application. (For example, if the application is an application capable of running on a machine that has the WINDOWS operating system installed on it, the application silo functions as if it were a regular WINDOWS system to the application.) The silo restricts writes to the computer's file system and registry so that processes running in the silo are only able to modify selected portions of the file system and registry but the operating system provides a silo-specific view of the file system and registry to the processes running in the silo so that the processes running in the silo “think” they have full write access to the system file system and registry. The silo does not have its own instance of the operating system.

A silo is an intra-operating system isolation/containment mechanism that provides for the isolation of a process running on a computer. The silo enables the controlled sharing of some files and restricts access to other files by creating a view of the file system for the process running in the silo. The view appears to a process running in the silo to be a single directory which is the union of two physical file system directories, the system file system and the file system files on the removable medium. That is, the files available to an application depend on the files the application “sees” and the file system that an application running in a silo “sees” is a view that merges the system file system and the file system files on the removable medium.

Similarly, the silo controls sharing and restricted access to the entries in the registry by creating a view of the registry for the process running in the silo. The registry view appears to a process running in the silo to be a single registry which is the union of two or more physical registries, the system registry and the registry on the removable medium.

Once the application starts up in the application silo, any changes to system configuration and/or system settings are written to the private copy of these files that exist on the removable medium and which typically are associated with and belong to the application on the removable medium. Selected access to areas of the system file system (e.g., to the My Documents directory) can optionally be given to the application. When the application exits and the removable medium is removed from the computer, the silo is deleted. Any changes to system configuration and/or system settings can be written back to the application private store on the removable medium or may be discarded.

In some embodiments of the invention, when a removable medium is inserted into the computer, the application is run in a silo which is sandboxed or isolated from the rest of the applications running on the machine. A sandbox is created by creating a silo, merging the registry elements on the removable medium with a read-only view of the machine registry, and creating a view of the file system by merging the files on the removable medium with a read-only subset of the files of the machine file system. Writes to the computer's registry or file system may be prohibited. Instead, when a write is to be made to one of the files or elements of the registry represented in the view, the write is made to the files or registry values on the removable medium. Alternatively, changes may be written to a scratch area on the computer. The scratch area may be and typically is discarded upon removal of the removable medium.

Interactions between the application on the removable medium and the system may be limited to reading from the file system and registry views provided to the application and writing to selected areas of the file system (e.g., to My Documents). Because an application is not able to write to the actual system registry, the behavior of the application is limited. For example, suppose that the application provided and that is to be run on the removable medium is an ACROBAT reader. The ACROBAT reader typically provides an extension to an Internet browser such as INTERNET EXPLORER or NETSCAPE. Because ACROBAT will be run in its own silo, it will not be called as an extension from the Internet browser that is already installed on the computer because the machine-side registry view seen by the Internet browser is different that the one provided to ACROBAT.

The above described behavior makes embodiments of the invention ideal for use in environments such as those presented today in a kiosk, hence, one contemplated application of the above described embodiment is use in a kiosk-type environment. Kiosks are commonly seen in public places and provide computer and Internet related services by providing a computer and monitor for public use. When a removable medium including software according to embodiments of the invention, the user is able to run the software on the kiosk computer without leaving personal information or data on the kiosk computer or modifying the configuration of the kiosk's operating system.

Kiosks are commonly used today in airports, in tourist venues (to provide information on hotels, restaurants, or public transportation, etc.), at trade shows and in retail stores. For example, some in-store kiosks enable shoppers to link to a web site where customers can browse for items not physically located in the store and enable salespeople to access information about merchandise, such as product specifications, warranty information, and pricing comparisons. In another contemplated use, when a removable medium is inserted into a computer, an experience akin to a new log-on to a kiosk may be presented to the user. Results can be saved back to the removable medium. Optionally, more of the user environment (such as the user's documents and settings) can be saved to the removable medium.

In other embodiments of the invention, the application appears to be part of the user environment and is able to extend the system. For example, an ACROBAT reader on the removable medium becomes callable from the Internet browser. In these embodiments, after the silo is created and the merged views are provided, application-specific actions are run that introduce the necessary linkage on the machine. The linkage may be a set of key-value pairs that are introduced into the machine registry. Upon removal of the removable medium, the linkages are removed. The code that maintains the linkage may be described in a declarative manifest or special code that is run upon insertion/removal of the medium.

In other embodiments of the invention, the application appears to be part of the user environment and is able to extend the system but instead of the above-described set of actions, the user-interface (the shell) portion of the Internet browser is restarted in the silo. When the removable medium is inserted, a new program appears in the listing of programs. The new program can act as an extension to existing programs and can change the settings of the shell and so on but when the removable medium is removed, these settings are discarded.

### Exemplary Computing Environment

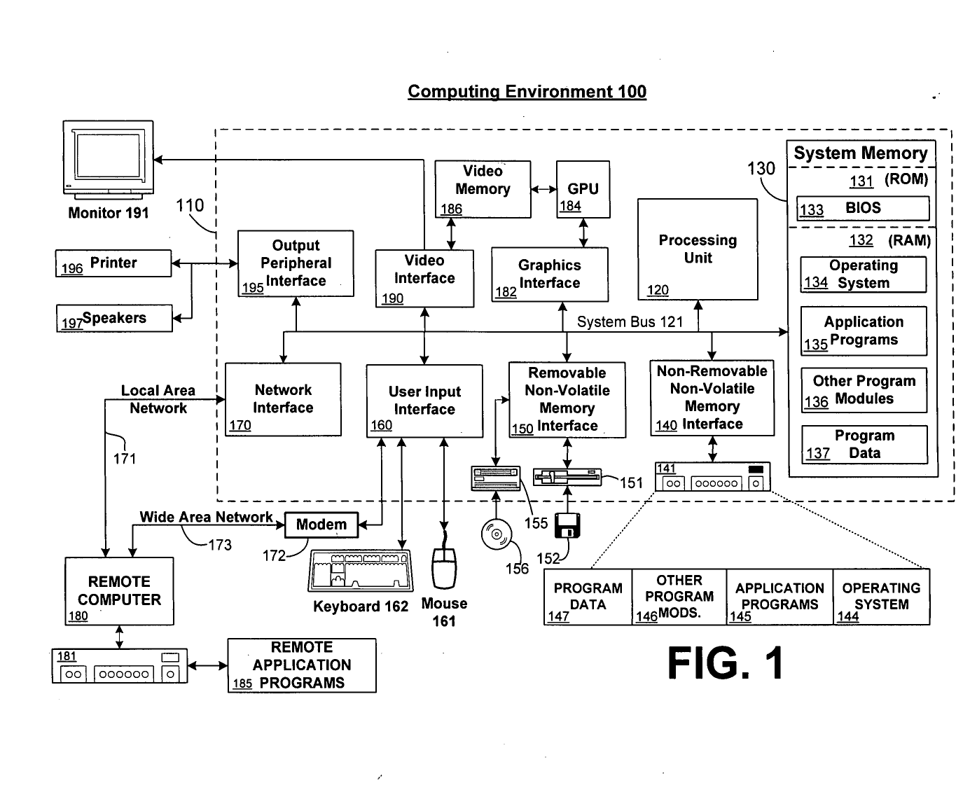

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (JSB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

### Running Applications from a Removable Medium

An application-specific view of a file system directory is created by a silo by merging a system file directory and a file directory on a removable medium into a single application-specific directory which is exposed to an application running in the silo. All (or all but a specified portion) of the system file directory portion of the application-specific directory may be read-only (to the application). The portion of the application-specific file directory coming from the removable medium file directory can be specified to be read-only or writable to the application running in the silo. An application-specific view of a registry is created by a silo by merging a system registry and a removable medium registry into an application-specific registry which is exposed to an application running within the silo. All (or all but a specified portion) of the system registry portion of the application-specific registry may be read-only (to the application). The portion of the application-specific file registry coming from the removable medium file registry can be specified to be read-only or writable to the application running in the silo.

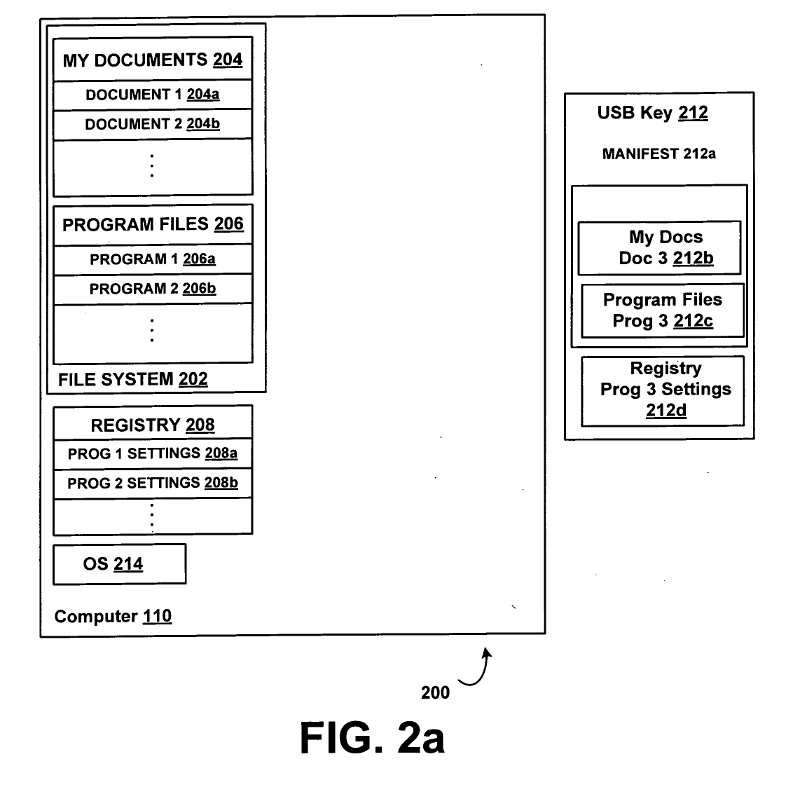

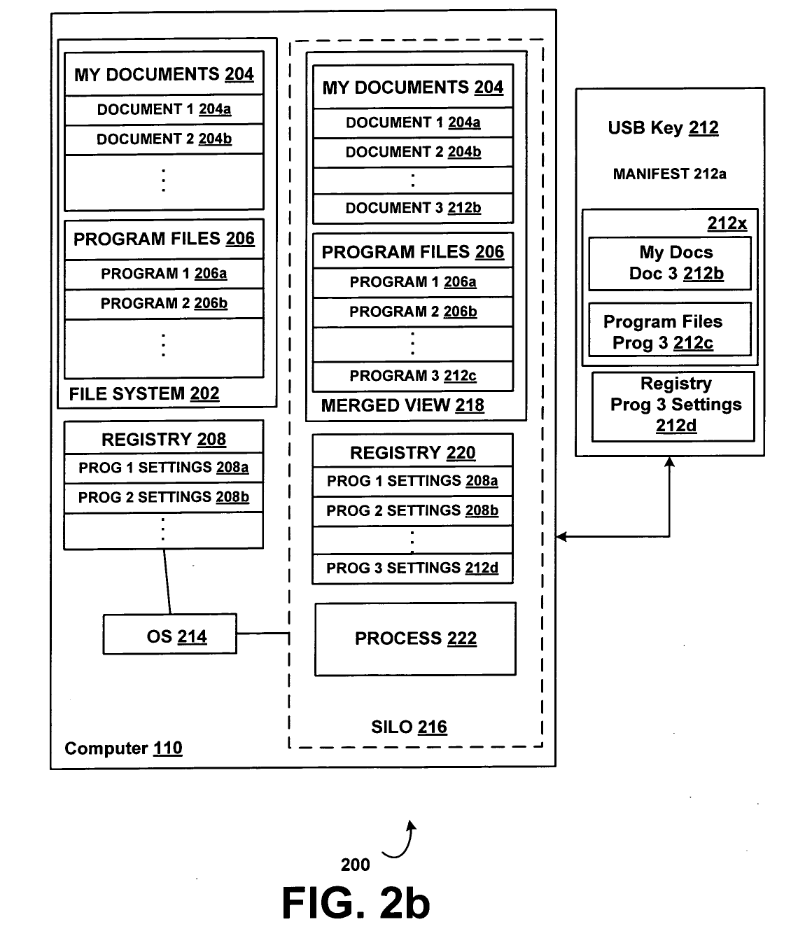

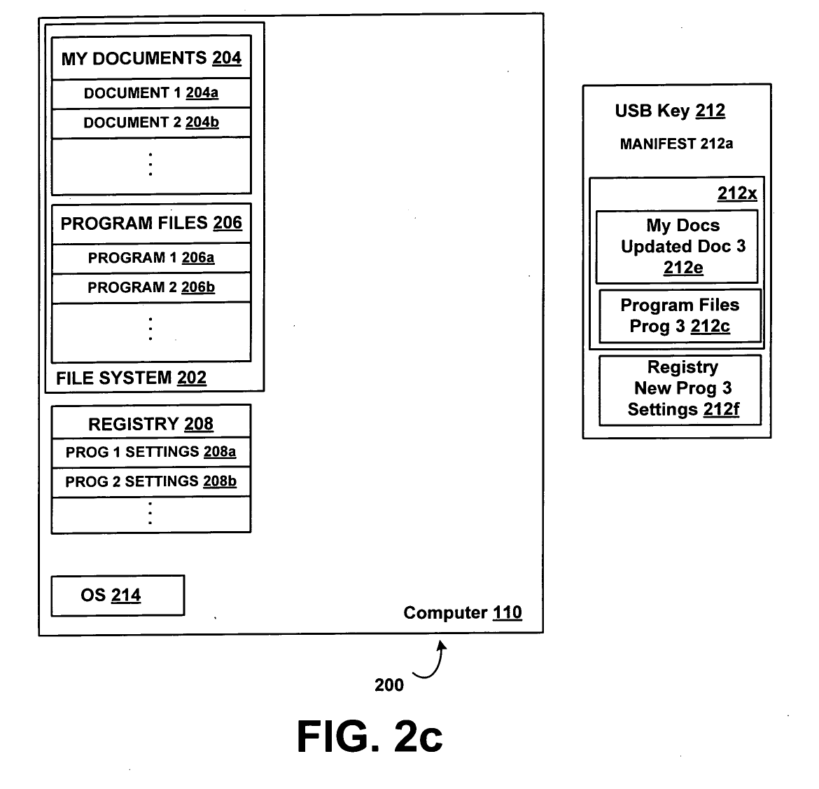

FIGS. 2a-c illustrate embodiments of a system 200 for running applications that are not installed on a computer from a removable medium inserted into or otherwise connected to the computer. System 200 may reside on one or more computers such as computer 110 described above with respect to FIG. 1. FIG. 2a represents a system before a removable medium is inserted (or otherwise connected). FIG. 2b represents the system while the removable medium is inserted in the machine and FIG. 2c represents the system after the removable medium has been removed. In FIG. 2a, an operating system such as WINDOWS, Linux or other operating system is represented by operating system (OS) 214. The system file system is represented by a file system 202 which may include data files or application state (represented by the My Documents directory 204 in which a number of files are represented by Document 1 204a and Document 2 204b, etc.). File system 202 may also include a number of program files such as Program 1 206a and Program 2 206b, etc. in a Program Files directory 206. A registry (for operating systems that store program settings in a special structure) is represented by Registry 208. In FIG. 2a, program settings for Program 1 206a are represented by registry entries 208a and program settings for Program 2 206b are represented by registry entries 208b and so on.

A removable medium is represented in FIG. 2a by USB key 212. USB key 212 in some embodiments of the invention includes one or more of the following: a manifest as described above, represented by manifest 212a, a (typically small but not necessarily so) program files directory that includes those program files (e.g., Program 3 212c) required by the application that is to be run on the USB key without being installed on computer 110, and data files (represented by the My Documents directory that includes Document 3 212b, representing data files required by the application and application state generated by the installation program and/or subsequent runs of the application. The USB key data files and program files together represent the file system files 212x of the USB key. In addition a Registry for a removable medium is represented by Program 3 settings 212d. Prior to provisioning, Document 3 212b and registry settings 212d may be minimal or null.

FIG. 2b illustrates computer 110 during execution of the application that has not been installed. Upon insertion or connection of the removable medium (e.g., USB key 212) to the computer 110 a sandboxed execution environment for the application to be run (e.g., program 3 212c) is generated. A silo 216 is created and a merged application-specific directory 218 and a merged application-specific registry 220 is created. As may be appreciated from FIG. 2b, merged directory 218 includes entries from both the system file system 202 and the removable medium file system files (Document 3 212b and Program 3 212c) merged together. Similarly, the merged registry 220 includes entries from both the system registry 208 and the removable medium registry 212d merged together. In some embodiments of the invention, the entity that appears to the application (e.g., Program 3) running in silo 216 (represented by process 222) to be a single physical directory is in fact an illusion (represented by dashed lines in FIG. 2b) created by links and is not physically in existence either as a virtual (stored in memory) entity or physical (persisted on stable storage media) entity. In some embodiments the merged file system directory 218 and merged registry view 220 are virtual directories. As process 222 executes, registry entries may be changed, and data files may be created or updated. When changes to registry entries or additional registry entries are made, or when changes to data files are made or additional data files are created, these changes and additions may optionally be written back to the removable medium 212 (i.e., Document 3 212b on USB key 212 is updated, for example, or new Registry Program 3 settings 212d). Instead the changes may persist (in the views 218 and 220) only while the application is executing, and upon removal of the removable media, the changes and additions may be discarded. In some embodiments of the invention, in addition or instead of being written to the removable medium, the changes and additions are made to a specified area of the system file system/registry.

FIG. 2c represents computer 110 after the process 222 has terminated. Suppose for example, that changes resulting from the execution of the application were to be written back to the removable medium. Suppose changes were made to Program 3 settings. The new Program 3 settings may be persisted onto the removable medium (represented in FIG. 2c by New Program 3 Settings 212f. Suppose Document 3 212b was updated during execution of the application. The changes to the document may be persisted onto the removable medium (represented in FIG. 2c as Updated Document 3 212e). It will be appreciated that the changes made and the persisting of the changes are performed by the silo mechanism—that is, the application is not modified (e.g., to understand that it is running in a silo, for instance). The silo 216 is deleted, and all the application-associated state may be removed from computer 110. File system 202 and registry 208 are unchanged by the execution of the application run from the removable medium (e.g., Program 3 212c).

In other embodiments of the invention, specified portions of the file system or registry may be read-write accessible to the application running in the silo. For example, the application may have been granted read write access to My Documents directory 204 of the system file system 202. In this case, Updated Document 3 212emay be written to the My Documents directory 204. Similarly, New Program 3 Settings 212f may be written to the system Registry 208 of FIG. 2c. Alternatively, according to another option all the updated files and registry values may be discarded.

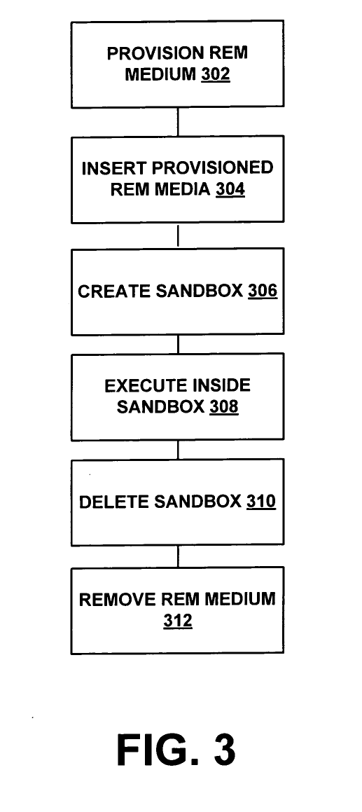

FIG. 3 is a flow diagram of a method for running an application from a removable medium without installation of the application on the computer. In some embodiments this is done using a silo mechanism as described above. Removable media as used herein includes removable disks, CD ROMS, DVDs, USB keys, flash memory devices, flash drives, pen drives, chip sticks, thumb drives, and other such devices not yet known or developed. At step 302, the removable medium is provisioned. Provisioning the removable medium means packaging all the necessary elements onto the removable medium so that when the removable medium is inserted into the computer, the application can be run without installation onto the computer (as described above). Step 302 in some embodiments is contemplated to be required to be run only once to create a master copy of the removable medium, not each time the removable medium is inserted into a computer. Alternatively, some portions of provisioning may be performed each time the removable medium is inserted into a computer, even if the removable medium was previously inserted into that computer. In yet another embodiment, some portions of provisioning may be performed whenever the removable medium is inserted into a computer for the first time (for that computer).

Provisioning may require creating additional elements required for the application to be able to be run without installation onto the computer. To make the off-the-shelf software able to be run without installation and without leaving application-associated state on the computer, the installation software may be run once for initialization purposes and the values set by the installation software may be saved on the removable medium. For example, a removable medium as known today that houses an application that requires installation onto a computer to be run, typically includes program files needed to execute the application, program files that install the application onto the computer, data files, links, shortcuts, and so on. In contrast, in accordance with embodiments of the invention, the installation software is run once, in order to obtain necessary settings and values. These values are saved on the removable medium. The installation software itself may not be on the removable medium. In addition, code may be provided on the removable medium, that is to be run at the first time the application is run from the removable medium or whenever the removable medium is inserted into the computer. This code may perform the initialization of variables and values that is performed by today's installation software. This code may also enable the application to adjust to the hardware and software characteristics of the computer on which it is run. In addition, the removable medium may also be provisioned with a manifest. The manifest may describe a subset of a registry (i.e., the part of the registry used by or associated with the application) and a subset of a file system (i.e., the part of the file system used by or associated with the application). The manifest may describe the access attributes to be given to processes running in the silo.

In some embodiments of the invention, once the “master” removable medium has been created, the master has only to be copied to generate more copies of the provisioned removable medium. Hence the processing associated with provisioning or alternatively, portions of the processing associated with provisioning need not be repeated.

At 304 the provisioned removable medium is inserted into a computer such as the one described above with respect to FIG. 1. Upon insertion of the provisioned removable medium into the computer on which the application is to be run, the user is given the option to run inside a sandbox. Upon selection of this option, the environment in which the application is to run without installation onto the machine is created. The environment creates an illusion so that it appears to the application as if the application has been installed on the machine. That is, all the files, registry entries, variables values, etc. that an installed application expects to see are exposed to the uninstalled application so that it appears to the application as if the application has been installed on the machine. In some embodiments of the invention, this illusion is created by creating a silo that merges the state of the machine with all the state that the application wrote when the installation program was run during the provisioning step (which occurs the first time the uninstalled application is run from the removable medium) or with the state created by the uninstalled application the last time it was run. (As described more fully below, all the state that is created when the application is run (i.e., during subsequent runs) is stored back on the removable medium or in a specified area of the computer's file system.) The file system which is exposed to the application silo is a merge view which includes both the entries in the computer's file system and files on the removable medium. The registry exposed to the application silo is a view which includes both the entries in the computer's registry and the registry values on the removable medium. Thus, the application silo acts as an isolated execution environment that functions like a complete computer system with its own operating system to the application but does not include its own copy of the operating system. (For example, if the application is an application capable of running on a machine that has the WINDOWS operating system installed on it, the application silo functions as if it were a regular WINDOWS system to the application but does not have its own WINDOWS OS image.)

During creation of the sandbox, the user may have the option to specify the isolation properties of the sandbox. Alternatively, the isolation properties of the sandbox may be determined by a sandbox definition which is included in the manifest or in a separate sandbox definition file included on the removable medium. Contemplated isolation properties include the following:

all system files are read-only

some system files are writable

if some system files are writable, the name of the system writable files or directories

registry entries are read-only

specified registry entries are writable

files created or modified by the not-installed application are deleted upon application exit

files created or modified by the not-installed application are saved to the removable medium

a portion of the file system to which application writes are redirected (as for example, when the removable medium is read-only)

a portion of the user data that may be hidden or exposed with read-only access only or exposed read-write (e.g., a silo for a game can be prevented from looking at user private data or a silo for tax software may be allowed to write to the user's financial data files.) The definition of the sandbox is used by the silo to create the virtual merged file system and registry view which is exposed to the applications running in the silo.

At 308, in some embodiments of the invention, a menu is presented which provides one or more of the following options: prepare to run an application that has not been installed on the computer in the sandbox, execute an application that has not been installed on the computer inside the sandbox, or run an application that has been installed on the computer on the removable medium. The first option is selected the first time a new application on a removable medium is to be run in a sandbox. The second option may be selected for subsequent runs of the application. The last option enables the user to run an application that has previously been installed on the machine in the conventional (known) way, but enables the state, files, registry values, etc. to be written back to the removable medium instead of to system state, system files, etc. During execution of the application in the sandbox, the state, files, registry entry, etc. are updated onto the removable medium. At 310, after execution is complete, the sandbox is deleted. Deletion of the sandbox deletes the silo and any state created by execution of the application. At 312 the removable medium is removed.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A system for running an application on a computer from a removable medium comprising:
an operating system that creates a silo in response to connection of a removable medium on which is stored a plurality of files comprising a removable medium file system and a registry, wherein the silo presents a merged view of a system file directory and the removable medium file system to the application running in the silo.

2. The system of claim 1, wherein the silo shares the operating system of the computer.

3. The system of claim 1, wherein the silo presents a merged view of a system registry and the removable medium registry to the application running in the silo.

4. The system of claim 1, wherein the system file system or registry is read only access to the application running in the silo.

5. The system of claim 1, wherein the removable medium file system or registry is read-write access to the application running in the silo.

6. The system of claim 1, wherein changes in application-related state are persisted to the removable medium during execution of the application in the silo.

7. A method for running an application on a computer from a removable medium, without installing the application on the computer comprising:
creating a silo on the computer in response to insertion of the removable medium into the computer, wherein the silo presents a merged view of a system file directory and a removable medium file system directory to an unmodified off-the-shelf application running in the silo; and
executing the unmodified off-the-shelf application from the removable medium without copying the unmodified off-the-shelf application onto the computer, wherein the unmodified off-the-shelf application executes within the silo.

8. The method of claim 7, wherein a portion of the system file directory can be specified to be read-writable to the application running in the silo.

9. The method of claim 7, wherein the silo presents a merged view of a system registry and a removable medium registry to the unmodified off-the-shelf application running in the silo.

10. The method of claim 7, wherein changes in application-related state are persisted to the removable medium during execution of the application in the silo.

11. The method of claim 7, wherein changes in program settings are persisted to specified areas of the registry in the removable medium.

12. The method of claim 7, wherein the unmodified off-the-shelf application is packaged on the removable medium with a subset of a registry and file system directories and initialization code, wherein the initialization code performs initialization acts ordinarily performed during installation of the off-shelf-application onto a computer.

13. The method of claim 7, wherein the silo is deleted when the application terminates.

14. The method of claim 7, wherein a degree of access available to the application to the system file directory is user-specifiable.

15. A removable computer-readable medium having program code stored thereon that, when executed by a computing environment, causes the computing environment to:
create an isolated execution environment comprising a silo, wherein the silo presents to an unmodified off-the-shelf application executing in the silo, a merged view of a system file directory and a file directory on the computer-readable medium, wherein the file directory on the computer-readable medium comprises program files comprising the unmodified off-the-shelf application executing in the silo and data files associated with the application executing in the silo;
in response to user input, executing the application in the silo, wherein the application has read-only access to the system file directory and read-write access to the file directory on the computer-readable medium.

16. The computer-readable medium of claim 15, having further program code stored thereon, that when executed by the computing environment, causes the computing environment to:
present to the unmodified off-the-shelf application executing in the silo, a merged view of a system registry and a registry on the computer-readable medium.

17. The computer-readable medium of claim 16, having further program code stored thereon, that when executed by the computing environment, causes the computing environment to:
persist changes in application-related state during execution of the application in the silo to the removable medium.

18. The computer-readable medium of claim 16, having further program code stored thereon, that when executed by a computing environment, causes the computing environment to:
persist changes in program settings for the application in the silo to the removable medium.

19. The computer-readable medium of claim 16, having further program code stored thereon, that when executed by the computing environment, causes the computing environment to:
delete the silo when the application terminates.

20. The computer-readable medium of claim 16, having further program code stored thereon, that when executed by the computing environment, causes the computing environment to:
discard application-related state and application-related changes to system configuration and settings upon termination of the application.
